(19) United States
(12) Patent Application Publication
(10) Pub. No.: US 2026/0251244 A1
(43) Pub. Date: Aug. 27, 2026

(54) Grooved Pipe Element and Coupling

(71) Applicant: VICTAULIC COMPANY, Easton, PA (US)

(72) Inventors: Matthew A. Bowman, Palmer, PA (US); Thomas Nunnally, Telford, PA (US); Scott D. Madara, Nazareth, PA (US)

(21) Appl. No.: 19/546,326

(22) Filed: Feb. 21, 2026

Related U.S. Application Data
(60) Provisional application No. 63/761,629, filed on Feb. 21, 2025.

(51) Int. Cl. F16L 21/06; F16L 9/00

(52) U.S. Cl. CPC F16L 21/065; F16L 9/006

(57) ABSTRACT

A pipe element and a coupling are provided in combination. The pipe element has an endform comprising a circumferential groove. The groove is defined by a first groove side surface, a second groove side surface, and a floor surface contiguous with the first and second groove side surfaces. The coupling comprises a plurality of segments attached to one another end to end to surround a central space, attachment members for attaching the segments to one another, and an arcuate projection positioned on a side of each of the segments. The arcuate projection comprises a first mating surface configured to engage the first groove side surface, a second mating surface configured to engage the second groove side surface, and a third mating surface contiguous with the first and second mating surfaces. When received by the groove, the arcuate projection is configured to wedge into the groove, promoting a more rigid joint substantially around the circumference of the pipe element.

### CROSS REFERENCE TO RELATED APPLICATIONS

This application is based upon and claims priority to U.S. Provisional Application No. 63/761,629, filed Feb. 21, 2025, which application is hereby incorporated by reference in its entirety.

### FIELD

This disclosure concerns improved endforms for pipe elements joined by grooved mechanical couplings, couplings having keys compatible with improved endforms, and grooved coupling joints.

### BACKGROUND

Obtaining rigid connections in grooved coupling joints is challenging due to many factors, including that grooved coupling joints rely on a smaller key of the coupling fitting into a larger groove, creating the opportunity for some “play” between those components that reduces rigidity. This play can result in reduced axial, angular, and torsional rigidity of the joint, which may be undesirable in certain applications where a more secure connection is desirable.

Rigidity of grooved coupling connections may be accomplished by clamping the groove forcefully, e.g., forcing the arcuate surface of the key forcefully against the floor of the groove to increase the friction and slightly ovalize the pipe cross-section to increase rigidity. However, this method has drawbacks, especially as piping is made thinner, as clamping the groove floor is dependent on pipe stiffness, and thinner pipe is less stiff. As a result, the effectiveness of this approach diminishes with thin wall pipe, which is increasingly used in modern piping systems due to its reduced weight and material cost.

It is also known to utilize grooved couplings with angled bolt pads that, as the bolts are tightened, cause the segments to rotate relative to one another to cause local contact at the sidewalls of the groove in order to more firmly grip the pipe. However, the contact on the side of the grooves created by the angled pad style couplings is localized and does not act fully around the groove circumference. This localized contact may not provide sufficient rigidity for certain applications and may result in uneven stress distribution around the pipe circumference.

Additionally, conventional grooves and keys may allow some slippage of the coupling segments relative to the pipe element before the sidewalls of the key contact the sidewalls of the groove. This slippage can occur when the key has a cross-sectional area smaller than the cross-sectional area of the groove, leaving clearance between the key and the groove sidewalls. Such clearance may permit unwanted movement between the coupling and the pipe element, reducing the overall rigidity and reliability of the joint.

In view of the limitations and drawbacks of the above approaches, there is an opportunity to advantageously improve the performance and rigidity of grooved coupling joints.

### SUMMARY

In one aspect, a pipe element and a coupling are provided in combination. The pipe element has a sidewall surrounding a longitudinal axis and defining a bore. The longitudinal axis is a central axis of the pipe element. The sidewall has an outer surface. The sidewall comprises an endform and a tubular portion connected to the endform. The endform extends from an end of the pipe element to the tubular portion. The endform comprises a groove defined by the outer surface. The groove extends circumferentially around the bore. The groove comprises, a first groove side surface, a second groove side surface facing the first groove side surface and in spaced apart relation from the first groove side surface, and a floor surface contiguous with the first groove side surface and the second groove side surface. The first groove side surface is positioned between the end of the pipe element and the second groove side surface. The coupling comprises a plurality of segments attached to one another end to end surrounding a central space and the end of the pipe element. Attachment members are positioned at each end of the segments for attaching the segments to one another. An arcuate projection is positioned on a side of each of the segments. The groove of the pipe element is configured to receive the arcuate projection. The arcuate projection comprises a first mating surface configured to engage the first groove side surface, a second mating surface configured to engage the second groove side surface, and a third mating surface contiguous with the first mating surface and the second mating surface and facing the central space. The third mating surface is positioned between the first mating surface and the second mating surface. When received by the groove, the arcuate projection is configured to wedge open the groove.

In another aspect, a method of assembling a combination of a pipe element and a coupling is provided. The pipe element has a sidewall surrounding a longitudinal axis and defining a bore. The longitudinal axis is a central axis of the pipe element. The sidewall has an outer surface comprising an endform. The endform comprises a groove defined by the outer surface. The groove extends circumferentially around the bore. The coupling comprises a plurality of segments attached to one another end to end to surround a central space, attachment members for attaching the segments to one another, and an arcuate projection positioned on a side of each of the segments. The method comprises adjusting the attachment members to draw the plurality of segments from an initial condition to a tightened condition, wherein the arcuate projection wedges open the groove.

In one aspect, a pipe element has a sidewall surrounding a longitudinal axis and defining a bore. The longitudinal axis is a central axis of the pipe element. The sidewall has an outer surface. The sidewall comprises an endform and a tubular portion connected to the endform. The endform extends from an end of the pipe element to the tubular portion. The endform comprises a groove defined by the outer surface. The groove is configured to receive an arcuate projection of a coupling. The groove extends circumferentially around the bore. The groove comprises a first groove side surface terminating at a first end, a second groove side surface facing the first groove side surface and in spaced apart relation from the first groove side surface along the longitudinal axis, and a floor surface contiguous with the first groove side surface and the second groove side surface. The first groove side surface is positioned between the end of the pipe element and the second groove side surface. The groove is configured to flex open to receive the arcuate projection of the coupling.

In another aspect, a method of forming a pipe element is provided. The pipe element has a sidewall surrounding a longitudinal axis and defining a bore. The longitudinal axis is a central axis of the pipe element. The sidewall has an outer surface and an inner surface. The method comprises positioning the inner surface of the pipe element on an inner roller of a roller set. The inner roller comprises an inner roller body rotatable about a second axis. The method further comprises moving an outer roller of the roller set into contact with the outer surface of the pipe element. The outer roller comprises an outer roller body rotatable about a first axis. The method further comprises rotating the inner roller, thereby rotating the pipe element and the outer roller. The method further comprises forcing the inner and outer rollers toward one another to deform the pipe element to form an endform comprising a groove defined by the outer surface. The groove extends circumferentially around the bore. The groove comprises a first groove side surface, a second groove side surface facing the first groove side surface and in spaced apart relation from the first groove side surface, and a floor surface contiguous with the first groove side surface and the second groove side surface. The first groove side surface and the second groove side surface are configured to flex open upon receiving an arcuate projection of a coupling.

### BRIEF DESCRIPTION OF THE DRAWINGS

FIG. 1 is an isometric view of an example coupling joining together example pipe elements according to the disclosure;

FIG. 2 is an isometric view of an example pipe element according to the disclosure;

FIG. 3 is a front side view of the pipe element shown in FIG. 2;

FIG. 4 is a front side view of a second embodiment of the pipe element;

FIG. 5 is a front side view of a third embodiment of the pipe element;

FIG. 6 is a front side view of a fourth embodiment of the pipe element;

FIG. 7 is a left end view of the pipe element shown in FIG. 2;

FIG. 8 is a cross-sectional view of the pipe element taken along section line 8-8 in FIG. 7;

FIG. 9 is an isometric view of an example coupling according to the disclosure;

FIG. 10 is a front side view of the coupling shown in FIG. 9;

FIG. 11 is a right end view of the coupling shown in FIG. 9;

FIG. 12 is a top plan view of the coupling shown in FIG. 9;

FIG. 13 is a front side view of a second embodiment of the coupling;

FIG. 14 is a front side view of a third embodiment of the coupling;

FIG. 15 is a cross-sectional view of the combination coupling and pipe elements taken along section line 15,16 -15,16 in FIG. 1 in a tightened condition under a first tolerance;

FIG. 16 is a cross-sectional view of the combination coupling and pipe elements taken along section line 15,16 -15,16 in FIG. 1 in a tightened condition under a second tolerance;

FIG. 17 shows a cross-sectional view of a portion of an example combination coupling and pipe elements with the coupling in an initial condition;

FIG. 18 shows a cross-sectional view of a portion of an example combination coupling and pipe elements with the coupling in an intermediate condition;

FIG. 19 shows a cross-sectional view of a portion of the example combination coupling and pipe elements with the coupling in a tightened condition; and

FIG. 20 is an isometric view of an fourth embodiment of the coupling according to the disclosure;

FIG. 21 is a front side view of the coupling shown in FIG. 20;

FIG. 22 is a right end view of the coupling shown in FIG. 20;

FIG. 23 is a top plan view of the coupling shown in FIG. 20;

FIG. 24 is an isometric view of an example coupling joining together example pipe elements according to the disclosure; and

FIG. 25 shows a side view of an example roller set and pipe element according to the disclosure.

### DETAILED DESCRIPTION

The present disclosure can be understood more readily by reference to the accompanying detailed description, which includes examples, claims and drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” can optionally include plural referents unless the context clearly dictates otherwise. For example, use of the term “a channel” can represent disclosure of embodiments in which only a single channel is provided, and unless the context dictates otherwise, can also represent disclosure of embodiments in which a plurality of such channels are provided.

All technical and scientific terms used herein have the same meaning as commonly understood to one of ordinary skill in the art to which this invention belongs unless clearly indicated otherwise.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each (e.g., A and B, A and C, B and C, or A, B, and C).

As used herein “pipe” or “pipe element” is intended to mean any fluid pipe-like component including, but not limited to, pipe stock, pipe fittings such as elbows, caps and tees, as well as fluid control components such as valves, reducers, strainers, restrictors, pressure regulators and the like. When a feature is described herein with respect to a “pipe” or a “pipe element,” it is understood that such description represents disclosure of that feature with respect to a specific form of “pipe” or “pipe element” as indicated above. For example, unless otherwise indicated, description of a feature with respect to a “pipe element” is intended to provide disclosure of a pipe fitting having the described feature.

As used herein, when referencing the point or region where two surfaces or features come together, the term “transition,” “transition region,” or “transitions” means a change from one surface or portion to another surface or portion via practical geometric forms such as arcs, fillets, chamfers, and other more generalized concave or convex features, inflections, or blends between the surfaces or features, it being understood that perfectly flat surfaces or sharp corners may not be practical and in many cases undesirable. The term “transition,” “transition region,” or “transitions” may comprise edge portions at either or both ends of surfaces or features described herein.

As used herein, the term “contiguous” means that two surfaces are connected, either directly or through a transition region. Two contiguous surfaces may share a common edge or boundary, or may be connected by a transition region therebetween. As described herein, the transition region may comprise a radiused surface, a chamfered surface, a fillet, or other transitional geometry connecting the two surfaces. For example, a first surface and a second surface that are contiguous may meet at an apparently sharp edge, or may be connected by a curved or radiused transition region extending between the first surface and the second surface. In some aspects, a transition region connecting two contiguous surfaces may have a length or peripheral dimension that is less than a length or peripheral dimension of either of the two surfaces being connected. In some aspects, and without limitation, a transition region connecting two contiguous surfaces may have a length or peripheral dimension of less than about 10 mm, less than about 5 mm, less than about 3 mm, or less than about 1 mm. These dimensions are provided by way of example only and are not intended to limit the scope of the term “contiguous” or the dimensions of any transition region. The term “contiguous” does not require that the two surfaces be coplanar or tangent to one another.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, use of “substantially” (e.g., “substantially parallel”) or “generally” (e.g., “generally planar”) should be understood to include embodiments in which angles are within ten degrees, or within five degrees, or within one degree of the stated position or orientation.

The word “or” as used herein means any one member of a particular list and, in alternative embodiments, unless context dictates otherwise, can include any combination of members of that list.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the device, systems, and associated methods can be implemented and used without employing these specific details. Indeed, the device, systems, and associated methods can be placed into practice by modifying the illustrated device, systems, and associated methods and may be used in conjunction with any other apparatus and techniques conventionally used in the industry.

### Overview

Various embodiments of pipe elements, couplings, and corresponding methods are disclosed. As further discussed herein, it is contemplated that the disclosed pipe elements and couplings can be used to address or improve upon one or more of the deficiencies of existing grooved coupling joints. For example, it is contemplated that the disclosure can enable or provide grooved couplings having increased or improved rigidity, particularly for thin wall pipe applications, while promoting consistent engagement between the coupling key and the groove around the circumference of the pipe element.

The disclosed pipe elements have an endform comprising a groove that is configured to receive an arcuate projection of a grooved mechanical coupling. As disclosed herein, the geometry of the arcuate projections and the groove may promote wedging of the arcuate projection into the groove, including around the circumference of the pipe element, which may increase the rigidity of the joint. Unlike conventional grooves and keys that may allow slippage before the sidewalls of the key contact the sidewalls of the groove, the disclosed arcuate projection may axially fill the groove to prevent unwanted slippage and promote a more rigid joint.

The wedging action of the arcuate projection and the groove promotes a more rigid joint. The disclosed couplings may promote wedging by producing forceful contact between the arcuate projections of the segments and the first groove side surface and the second groove side surface of the groove over a broad tolerance range of groove diameters and a broad tolerance range of diameters of the arcuate projection surfaces. The wedging of the arcuate projection into the groove may provide more consistent engagement around the pipe circumference and may address the limitations of conventional angled pad style couplings that may provide only localized contact at the groove sidewalls.

### Combination of Grooved Coupling and Pipe Elements

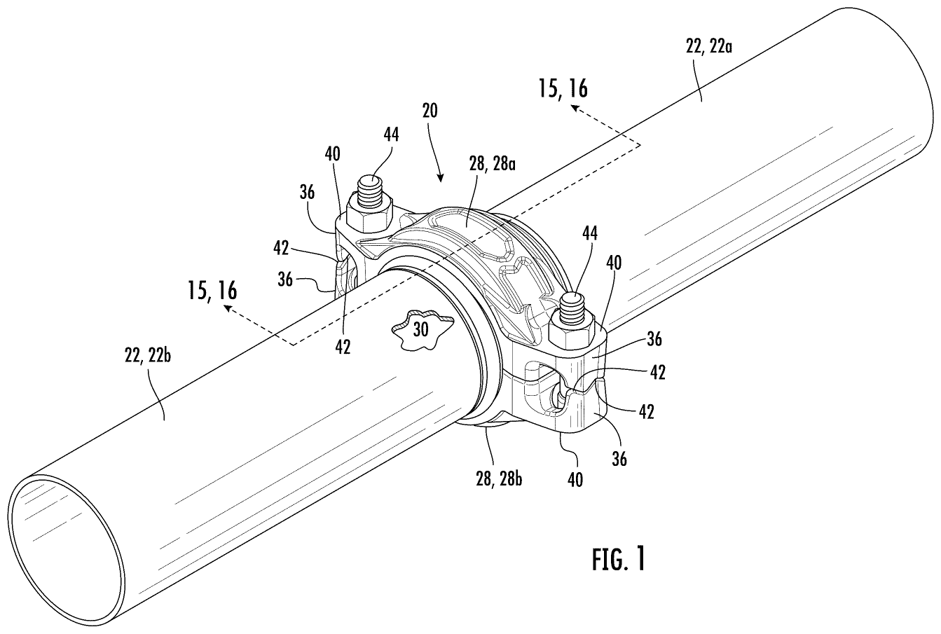

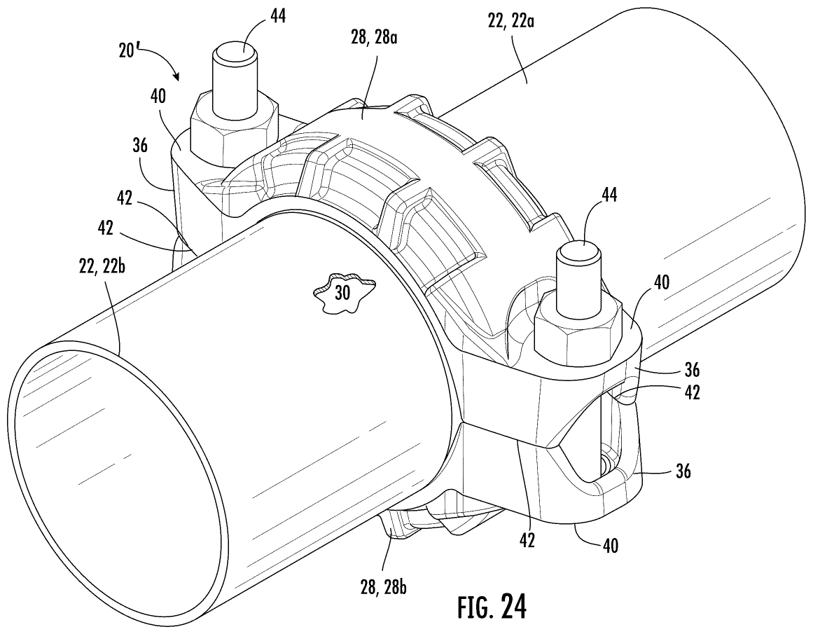

FIGS. 1 and 24 show an example grooved mechanical pipe coupling 20, 20′ according to the disclosure joining example pipe elements 22, in this example a first pipe element 22a and a second pipe element 22b, according to the disclosure. Coupling 20, 20′ comprises a plurality of segments 28, in this example a first segment 28a and a second segment 28b, configured to attach to one another end to end to surround a central space 30. The plurality of segments 28 are configured to attach to one another end to end to surround the central space 30 (e.g., by forming a loop or annular structure around the central space 30). The plurality of segments 28 are configured to surround the ends of the pipe elements 22a, 22b. Attachment of the segments 28a, 28b to one another is effected by attachment members 36 positioned at each end of the segments 28a, 28b. Attachment members 36 are configured to draw the segments 28a, 28b together to a tightened condition as described herein to join the first pipe element 22a to the second pipe element 22b. Exemplary pipe elements 22 and grooved pipe couplings 20, 20′, which can be provided and used together or independently of one another, are discussed further below.

### Pipe Elements

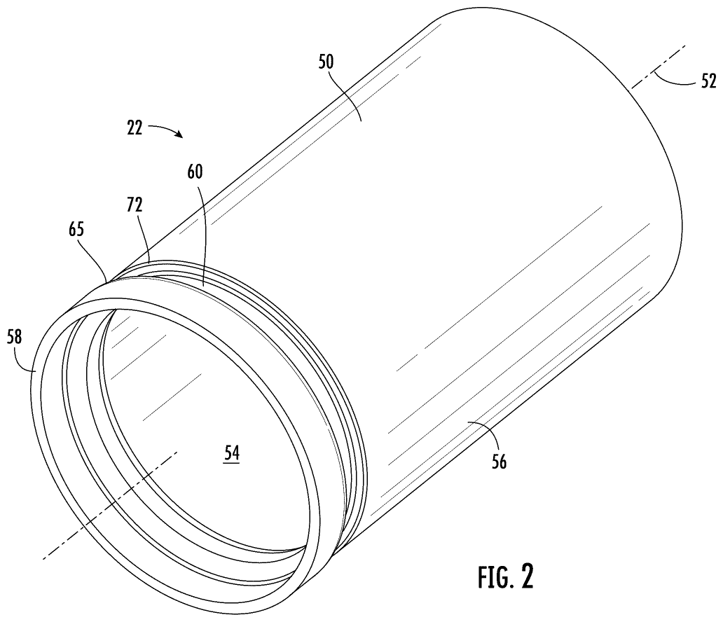

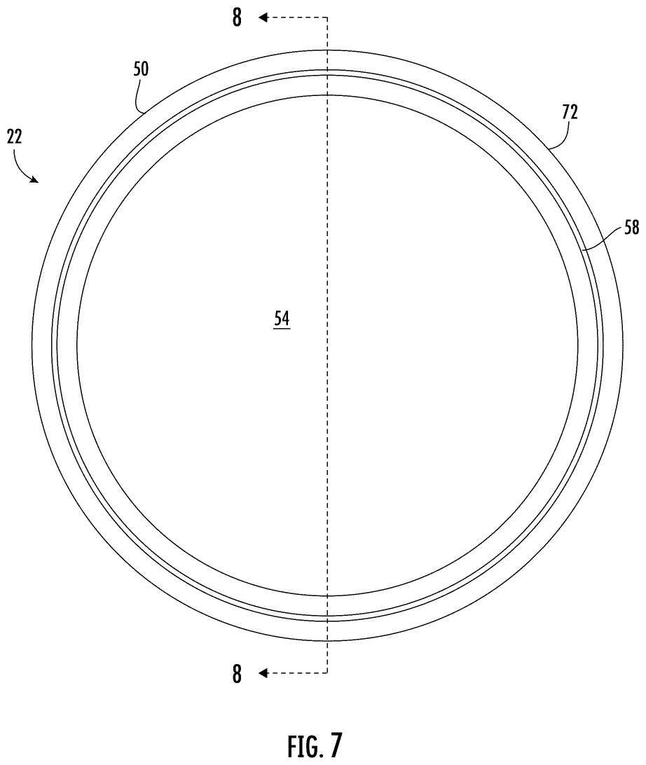

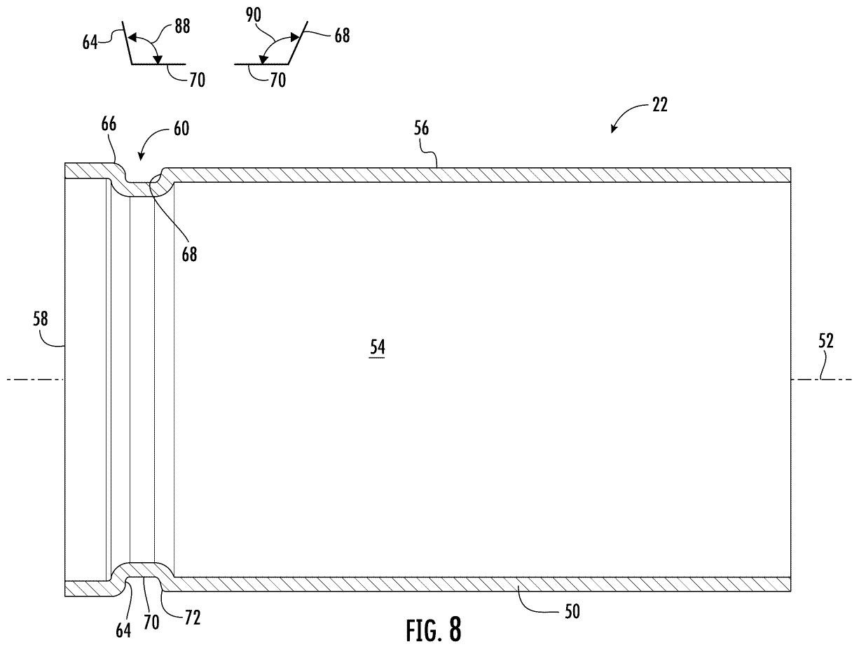

FIGS. 2-8 show an example pipe element 22. The pipe element 22 may be made of any conventional piping material, or other suitable materials, including malleable materials such as ferrous and nonferrous metals and polymers. Optionally, the pipe may be made of stainless steel. Optionally, pipe element 22 may be a thin wall pipe as understood in the industry, e.g., pipe that has a thinner wall than standard weight, Schedule 40 pipe, such as Schedule 10 pipe (as of the time of filing). The pipe element 22 comprises a sidewall 50 surrounding a longitudinal axis 52 and defining a bore 54 (see FIGS. 7 and 8). The longitudinal axis 52 is a central axis of the pipe element 22. The features of the sidewall 50, including the groove described herein may be understood with reference to a cross-sectional plane including the longitudinal axis 52. The sidewall 50 has an outer surface 56. As used herein, the outer surface 56 refers to the outward-facing surface of the sidewall 50 and includes all portions of the outward-facing surface regardless of the local geometry. The outer surface 56 includes surfaces within the groove, surfaces of the tubular portion, and any other outward-facing surfaces of the sidewall 50. For example, the floor surface and side surfaces of the groove are portions of the outer surface 56, even though these surfaces may be positioned at a smaller radius than other portions of the outer surface 56. Radii of features of the outer surface 56 described herein are measured from the longitudinal axis 52.

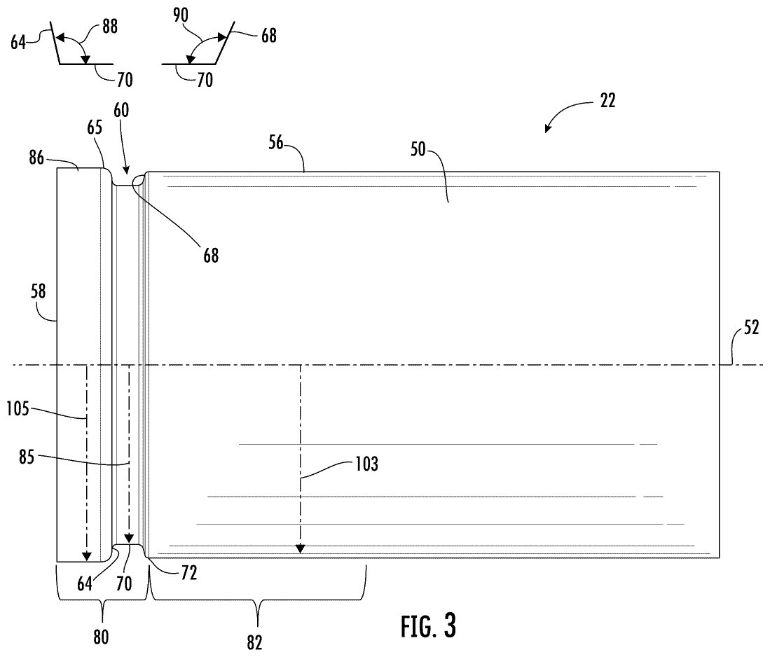

As shown in FIGS. 3-6, the sidewall 50 comprises an endform 80 which is a formed end portion of the pipe element 22. A tubular portion 82 of the sidewall 50 is connected to the endform 80. The tubular portion 82 may be contiguous with the endform 80. The endform 80 may extend from an end 58 of the pipe element 22 to the tubular portion 82. The endform 80 comprises a groove 60 defined by the outer surface 56 and extending circumferentially around the bore 54 (shown in FIGS. 7-8). The groove 60 is positioned proximate to the end 58 of the pipe element 22. As used herein to describe a location relative to an end of a pipe element, the term “proximate” means that said location is closer to the stated end than to the opposing end of the pipe element. Optionally, the term “proximate” can further indicate that said location is closer to the stated end than to a transverse plane that is perpendicular to a longitudinal axis of the pipe element and equidistant from the opposing ends of the pipe element. Similarly, the term “distant” as used herein to describe a location relative to an end of the pipe element 22 that is closer to the opposite end than the stated end.

The groove 60 comprises a first groove side surface 64 terminating at a first end 65. As described herein, in some aspects, the first end 65 may be a summit 66. The first groove side surface 64 may include transitions at either or both of the ends of the surface 64. The first groove side surface 64 may be planar, concave, convex, or combinations thereof. For example, the first groove side surface 64 may have an S-shaped profile in a cross-sectional plane including the longitudinal axis 52. The groove 60 comprises a second groove side surface 68 facing the first groove side surface 64 and in spaced apart relation from the first groove side surface 64. The first groove side surface 64 is positioned between the end 58 of the pipe element 22 and the second groove side surface 68. The second groove side surface 68 terminates at a second end 72. The second groove side surface 68 may include transitions at either or both of the ends of the surface 68. The second groove side surface 68 may be planar, concave, convex, or combinations thereof. For example, the second groove side surface 68 may have an S-shaped profile in a cross-sectional plane including the longitudinal axis 52. Optionally, the second end 72 of the second groove side surface 68 may be contiguous with the tubular portion 82. A floor surface 70 of the groove 60 is contiguous with the first groove side surface 64 and the second groove side surface 68. The floor surface 70 has a width extending parallel or substantially parallel to the longitudinal axis 52. The floor surface 70 may be oriented parallel or substantially parallel (for example within 5° of parallel) to the longitudinal axis 52. A radius 85 of the floor surface 70 measured from the longitudinal axis 52 may be less than any other radius measured from the longitudinal axis 52 to any part of the outer surface 56 of the endform 80. The radius 85 of the floor surface 70 measured from the longitudinal axis 52 may be less than a minimum radius 103 of the outer surface 56 of the tubular portion 82 measured from the longitudinal axis 52. The first groove side surface 64 is oriented at a first groove side angle 88 relative to the floor surface 70. The second groove side surface 68 is oriented at a second groove side angle 90 relative to the floor surface 70. When the first groove side surface 64 and/or the second groove side surface 68 is non-planar, the first groove side angle 88 and/or the second groove side angle 90 may be measured relative to a line extending between the endpoints of the respective surface in a cross-sectional plane including the longitudinal axis 52. Optionally, where there is a transition between surfaces, an endpoint of one of the surfaces may be taken as the midpoint of the transition between the surfaces. For example, if there is a transition (for example, a fillet) between the floor surface 70 and the first groove side surface 64, an endpoint of the first groove side surface 64 is the midpoint of the transition between the floor surface 70 and the first groove side surface 64. The second groove side angle 90 may be greater than the first groove side angle 88. The first groove side angle 88 may be an obtuse angle. The second groove side angle 90 may be an obtuse angle. The first groove side angle 88 and the second groove side angle 90 may each be from about 90° (for example, within 5° of 90°) to about 120° (for example, within 5° of 120°). Optionally, the first groove side angle 88 may be from 90° to 100° Optionally, the second groove side angle 90 may be from 100° to 110°. Thus, in some exemplary configurations, the first groove side angle 88 is from 90° to 100°, and the second groove side angle 90 is from 100° to 110°, with the second groove side angle 90 being greater than the first groove side angle 88.

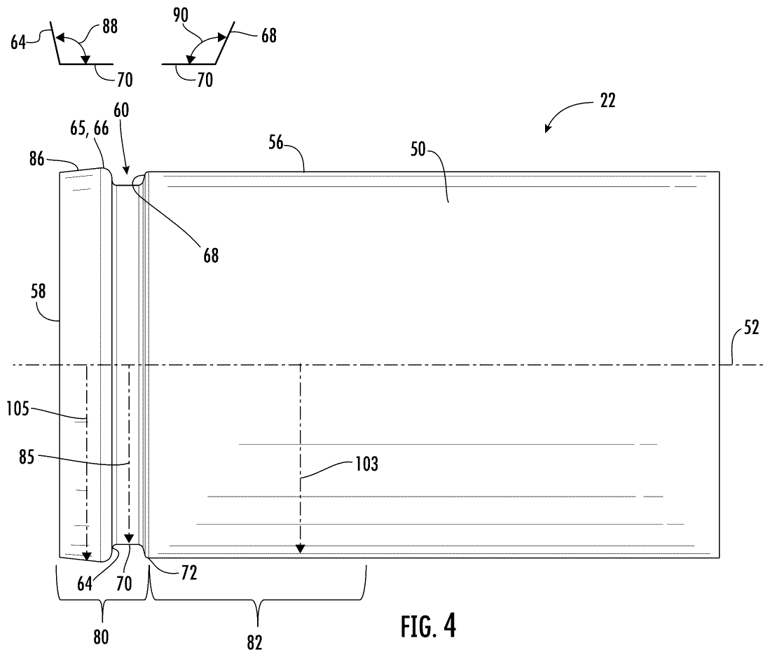

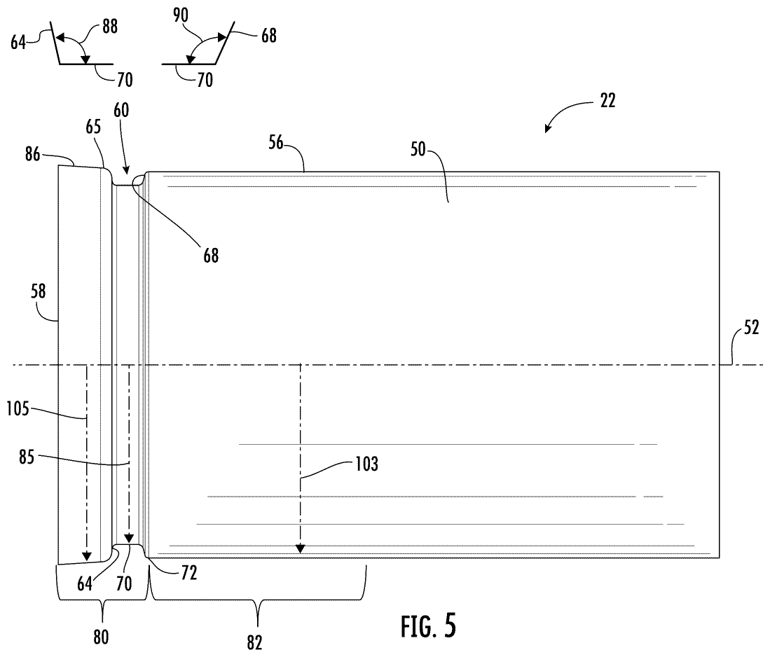

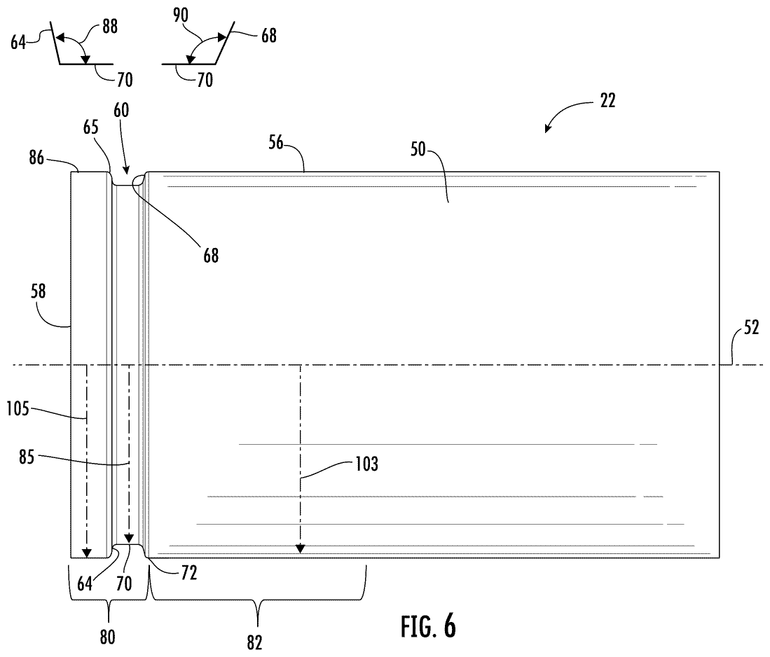

Optionally, in the example pipe element 22 shown in FIGS. 3-6, the endform 80 further comprises a sealing surface 86 positioned between the first groove side surface 64 and the end 58 of the pipe element 22. The sealing surface 86 may extend from the first groove side surface 64 to the end 58 of the pipe element 22. Optionally, the sealing surface 86 may be contiguous with the first groove side surface 64. The sealing surface 86 may extend from the first end 65 of the first groove side surface 64 to the end 58 of the pipe element 22. As shown in FIG. 3, the sealing surface 86 may be cylindrical or substantially cylindrical. Optionally, as shown in FIG. 6, the radius 105 of the cylindrical or substantially cylindrical surface 86 may be the same or substantially the same as the radius 103 of the tubular portion 82. Alternatively, as shown in FIG. 3, the radius 105 of the cylindrical or substantially cylindrical surface 86 may be greater than the radius 103 of the tubular portion 82. Optionally, as shown in FIG. 4, the sealing surface 86 may be frustoconical such that a radius of the sealing surface 86 measured from the longitudinal axis 52 at a first point may be less than a radius of the sealing surface 86 measured from the longitudinal axis 52 at a second point, wherein the first point is closer to the end 58 of the pipe element 22 than the second point to the end 58 of the pipe element 22. As shown in FIG. 4, where the sealing surface 86 is frustoconical such that the sealing surface 86 tapers inwardly from the first groove side surface 64 towards the end 58 of the pipe element 22, the first end 65 of the first groove side surface 64 may be summit 66. The sealing surface 86 may be positioned between the summit 66 and the end 58 of the pipe element 22. The sealing surface 86 may extend from the summit 66 to the end 58 of the pipe element 22. Optionally, as shown in FIG. 5, a radius of the sealing surface 86 measured from the longitudinal axis 52 at a first point may be larger than a radius of the sealing surface 86 measured from the longitudinal axis 52 at a second point, wherein the first point is closer to the end 58 of the pipe element 22 than the second point to the end 58 of the pipe element 22.

### Grooved Couplings

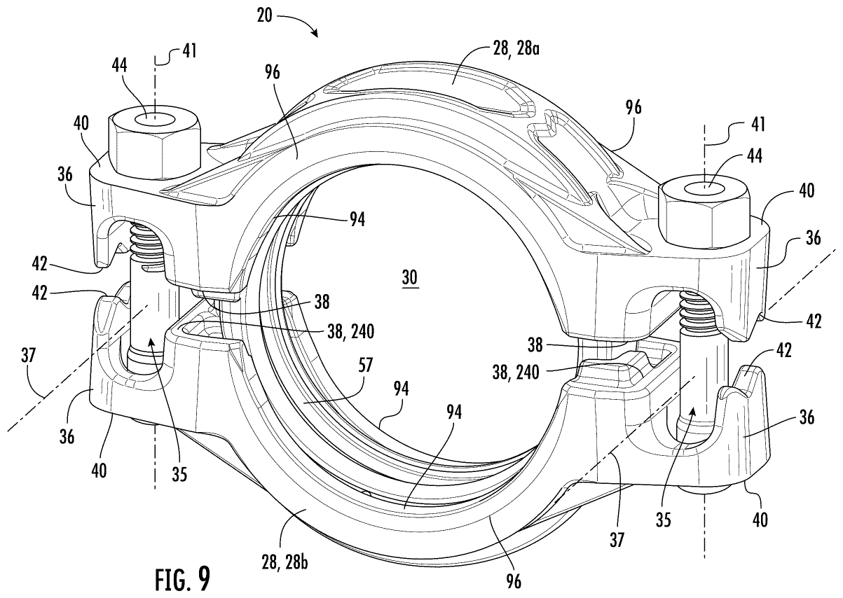

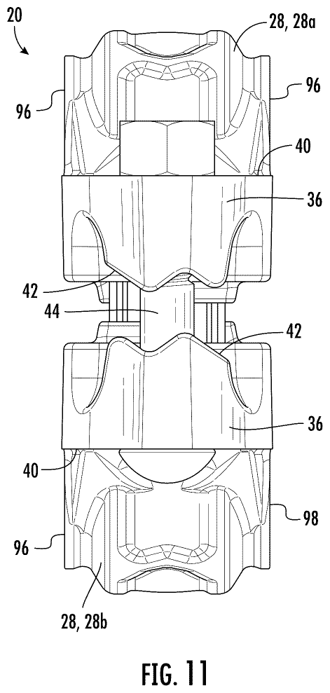

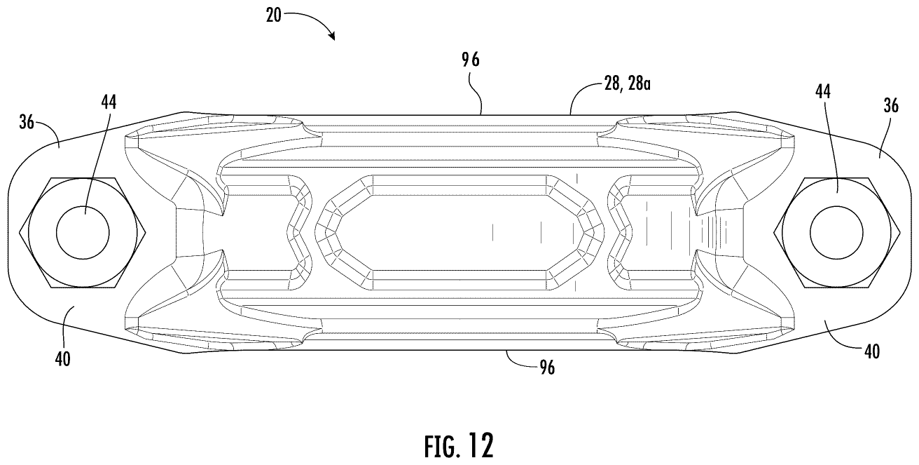

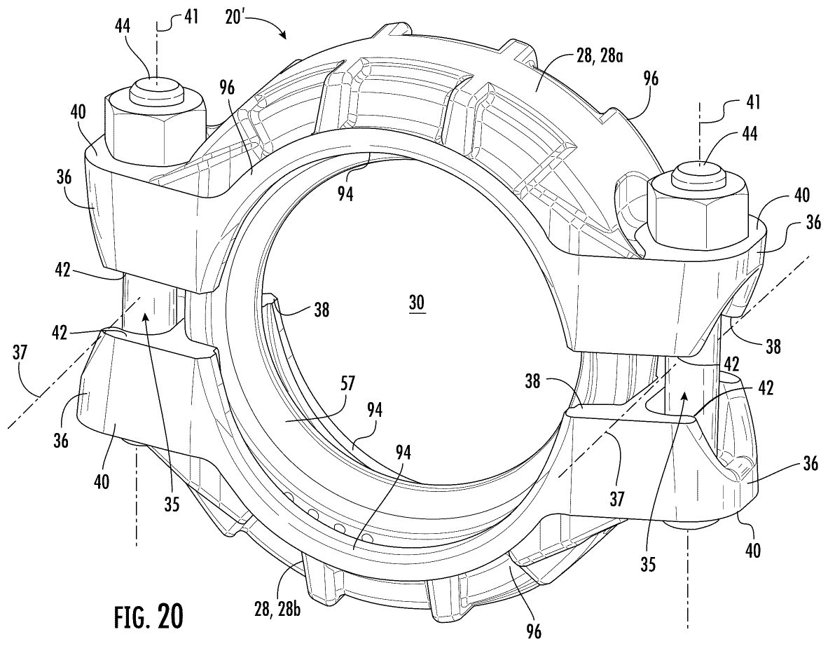

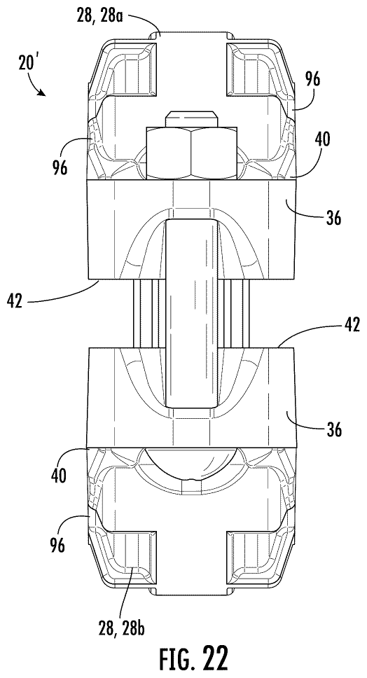

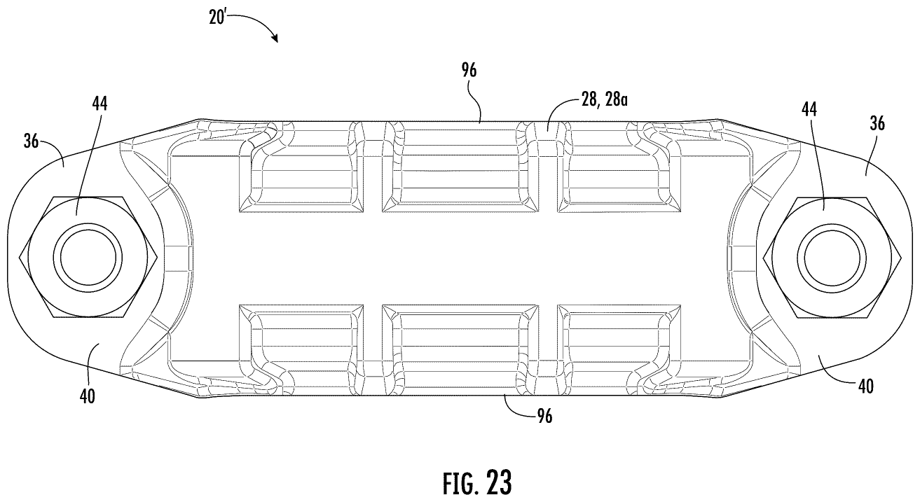

FIGS. 9-12 and 20-24 show an example grooved coupling 20, 20′. Couplings 20, 20′ according to the disclosure may take various forms. It is understood that the details of the coupling 20, 20′ described herein, including the arcuate projections (described herein) and the wedging effect of the arcuate projections in the groove (described herein), may be applied to various coupling configurations. FIGS. 9-12 show a first example coupling 20 according to the disclosure, and FIGS. 20-24 show a second example coupling 20′ according to the disclosure. The following description applies generally to couplings according to the disclosure (including coupling 20 and coupling 20′) unless otherwise indicated.

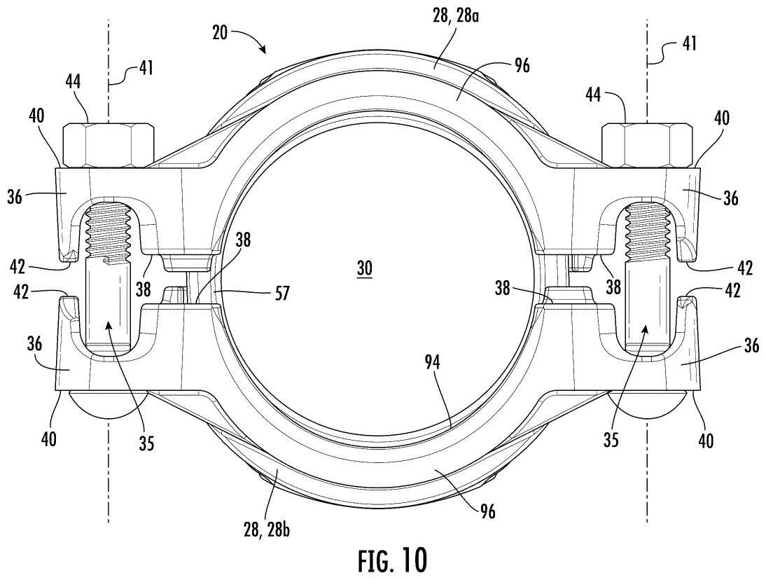

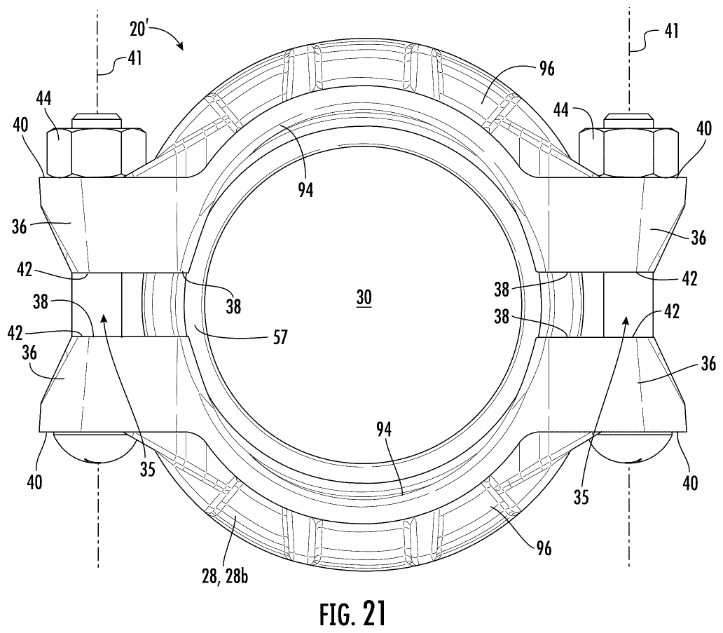

As shown in FIGS. 9-11 and 20-22, the attachment members 36 of the coupling 20, 20′ comprise lugs 40, wherein respective lugs 40 may be attached via fasteners 44. At least one fastener 44 is an adjustably tightenable fastener, such as a bolt and nut. Each lug 40 comprises an inner bolt pad surface 38. Optionally, each lug 40 may comprise a stop surface 42. As shown in FIGS. 20 and 21, the stop surface 42 of coupling 20′ may be contiguous with the inner bolt pad surface 38. Alternatively, as shown in FIGS. 9 and 10, each lug 40 of coupling 20 may define an opening 35 surrounding a first axis 37 oriented perpendicularly to a longitudinal axis 41 of the respective fastener 44 and extending through the lug 40 such that the stop surface 42 is spaced from the inner bolt pad surface 38. The bending stiffness may be tuned to a desired value by the sizing of the opening 35. As shown in FIGS. 1 and 24, in the tightened condition, the stop surfaces 42 of coupling 20, 20′ on respective ends of the segments 28a, 28b may engage each other. As shown in FIG. 24, stop surfaces 42 of coupling 20′ are shown as flat pads; however, the disclosure is not so limited and the stop surfaces may take the form of slanted pads, tongue and recess, and other known interfaces. Optionally, the coupling 20′ may be in the tightened condition when the fasteners are tightened a predetermined amount. In the tightened condition, stop surfaces 42 may be separated by a gap. The gap may account for practical tolerance variations of the pipe element 22 and couplings 20 and 20′ as disclosed herein.

As shown in FIG. 9, the inner bolt pad surface 38 of coupling 20 may comprise an action surface 240. The action surface 240 may be positioned between the central space 30 and stop surface 42. The fastener 44 may be positioned between the action surface 240 and the stop surface 42. The action surface 240 and the stop surface 42 may be oriented transversely to a longitudinal axis 41 of the fastener 44. Optionally, the action surface 240 and/or stop surface 42 may be oriented perpendicularly or substantially perpendicularly (for example within 10° of perpendicular) to the longitudinal axis 41 of the fastener 44. The geometry of respective stop surfaces 42 may be complementary. For example, the stop surfaces may define at least one receiving space and shape such that the shape of a stop surface 42 may insert into the receiving space of a respective stop surface 42 and/or vice versa to interlock respective stop surfaces 42.

To account for tolerances for the pipe surface, including, for example, pipe diameter, groove depth, groove width, and groove location in the pipe element and the tolerance range of the interfacing surface of the coupling, the coupling 20 may be adapted for different tightened configurations, including to address practical tolerance ranges. A person of ordinary skill in the art would understand the arcuate surfaces of the segments may be imperfect and references to the diameter or radius of elements, such as the arcuate surfaces, may be represented by a best fit curve. In exemplary configurations, the lugs 40 are adapted, upon tightening of the adjustable fastener 44, to assume either a first configuration, wherein the action surfaces 240 are in contact with one another and the stop surfaces 42 are in contact with one another, or a second configuration, wherein the stop surfaces 42 are in contact with one another, there being a gap between the action surfaces 240. In further exemplary configurations, the stop surfaces 42 on the lugs 40 engage one another to visually indicate that a proper installation of the coupling 20 has been achieved.

Optionally, upon adjusting the fastener 44 to draw the first segment 28a and the second segment 28b toward one another, engagement between the stop surfaces 42 on the lugs 40 may arrest rotation of the segments 28a, 28b relative to one another, wherein the rotation of the segments 28a, 28b may be caused by friction associated with the rotation of the fasteners, the geometry of the action surfaces, and/or the geometry of the stop surfaces.

### Formation of Joints

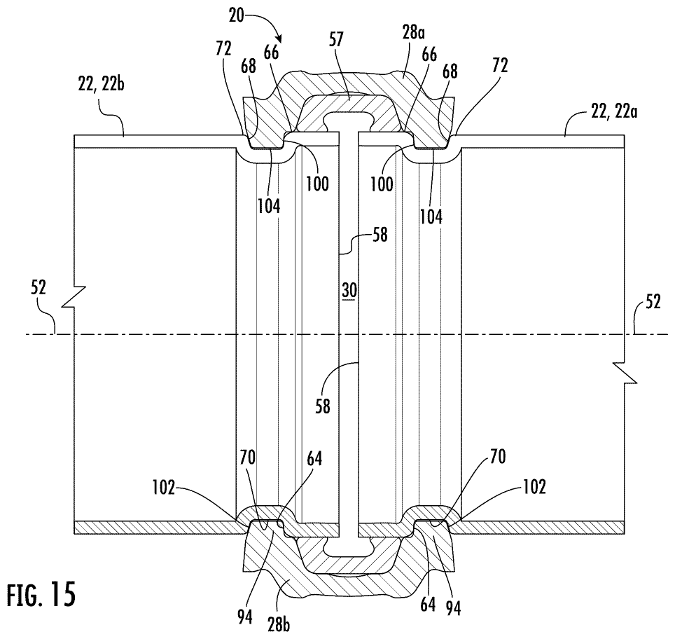

The coupling 20, 20′ comprises a ring seal 57 configured to be captured and compressed between the segment 28a, 28b and the pipe elements 22a, 22b (see FIGS. 15-19) when the segments 28a, 28b are drawn toward one another and into engagement with the pipe elements 22a, 22b to form a fluid tight joint.

In exemplary configurations, as shown in FIGS. 9-11, 13-14, and 20-22, the plurality of segments 28a, 28b are attached to one another end to end in a preassembled state. In the preassembled state, the plurality of segments 28a, 28b are supported in spaced relation while attached to one another to allow insertion of the pipe element 22 into the central space 30. The ring seal 57 may support the plurality of segments 28a, 28b in the preassembled state. One or more fasteners 44 may hold the segments 28a, 28b together and against the ring seal 57, which has sufficient stiffness to support the segments in the preassembled state, although other methods for maintaining the segments in a preassembled state, such as spacers, and spring-like elements, may be employed.

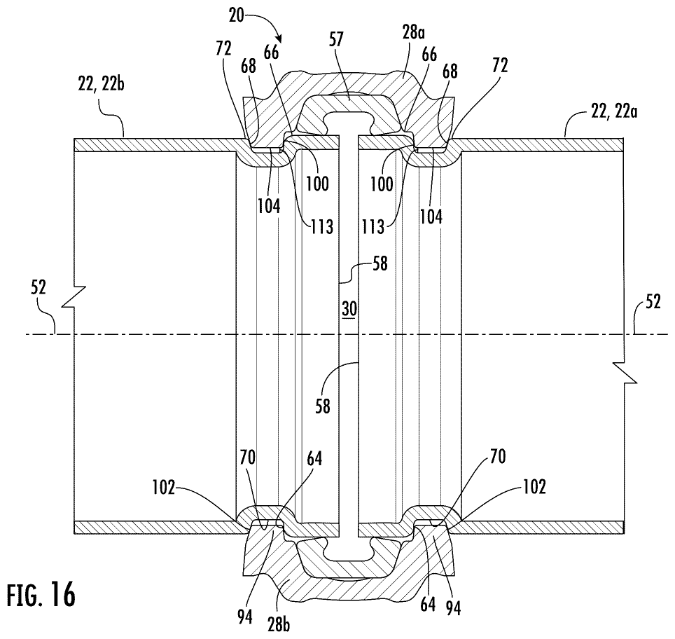

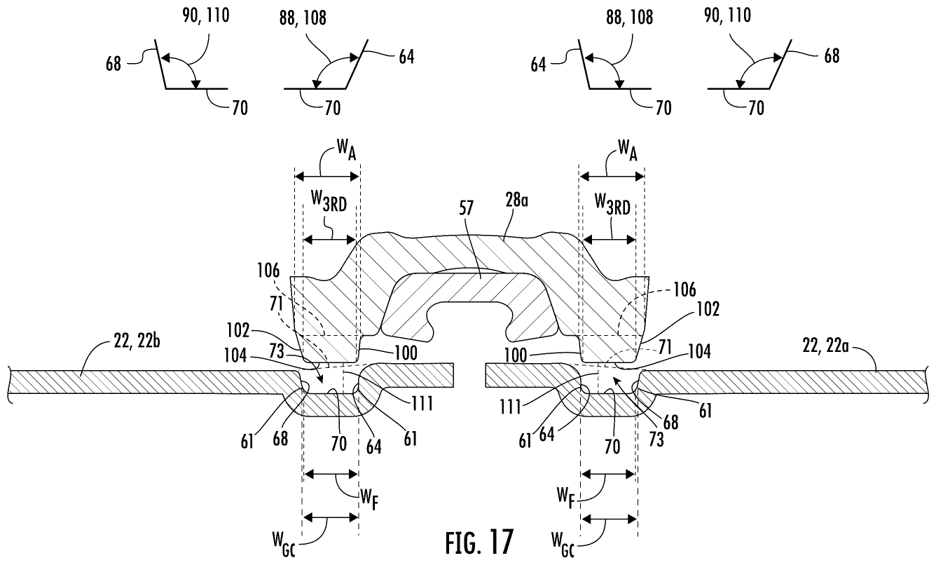

As shown in FIGS. 15 and 16, an arcuate projection 94 is positioned on at least one side 96 (e.g., both sides) of each of the segments 28a, 28b and is configured to engage with the groove 60. Thus, the coupling 20, 20′ has a plurality of arcuate projections 94 (e.g., with two arcuate projections on each segment of the coupling). In the following description, even when only a single arcuate projection is discussed, it is understood that the features related to that arcuate projection are applicable to other arcuate projections (optionally, every other arcuate projection) of the coupling. Each arcuate projection 94 projects radially inwardly from the respective side of each segment 28a, 28b. The arcuate projection comprises a first mating surface 100. The first mating surface 100 extends radially inwardly towards the central space 30 from the side of the segment 28a, 28b. The first mating surface 100 is configured to engage the first groove side surface 64. The arcuate projection comprises a second mating surface 102. The second mating surface 102 extends radially inwardly towards the central space 30 from the side of the segment 28a, 28b. The second mating surface 102 is configured to engage the second groove side surface 68. The second mating surface 102 faces away from the first mating surface 100. The arcuate projection 94 comprises a third mating surface 104 positioned between and contiguous with the first mating surface 100 and the second mating surface 102. The third mating surface 104 extends along the length of the arcuate projection 94. The third mating surface 104 faces the central space 30. The first mating surface 100 may taper towards the second mating surface 102 and the second mating surface 102 may taper towards the first mating surface 100 such that a width W_{A} of the base 106 of the arcuate projection 94 is wider than a width W_{3RD} of the third mating surface 104 (shown in FIG. 17). Except where otherwise indicated, it is contemplated that a “taper” or a “tapered” portion/surface can refer to any gradual decrease or narrowing in width or diameter, whether at a constant or variable rate. Optionally, the “taper” or “tapered” portion/surface can be a consistent/constant taper moving along a given length (e.g., a taper at a fixed angle). The width W_{3RD} of the third mating surface 104 extends perpendicularly or substantially perpendicularly (for example within 5° of perpendicular) to the length of the arcuate projection.

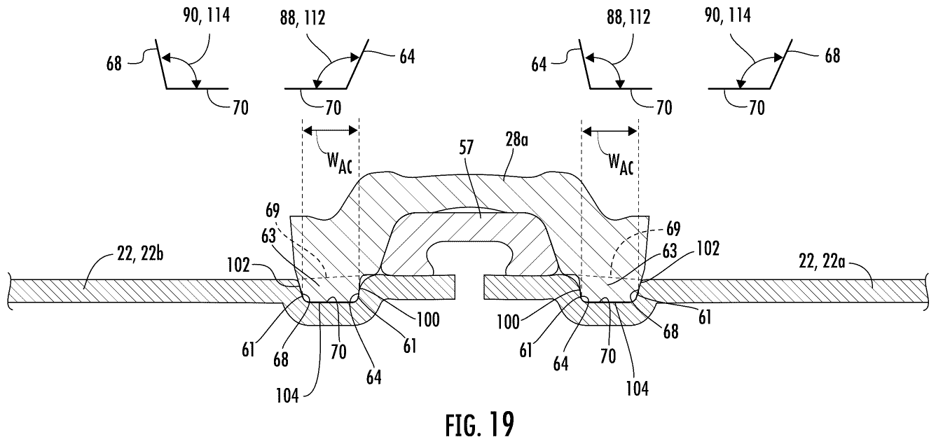

As shown in FIGS. 17-19, the plurality of segments 28a, 28b are configured to be drawn towards one another from an initial condition (shown in FIG. 17) (optionally, a preassembled condition (shown in FIGS. 9-11 and 20-22)) to a tightened condition (shown in FIGS. 1, 15, 16, 19, and 24). As shown in FIG. 17, in the initial condition, the third mating surface 104 is spaced from the floor surface 70 of the groove 60 by a first distance 111. As shown in FIGS. 15, 16, and 19, in the tightened condition, the third mating surface 104 engages the floor surface 70 of the groove 60 (FIGS. 15 and 19) or the third mating surface 104 is spaced from the floor surface 70 of the groove 60 by a second distance 113 (FIG. 16). The second distance 113 is less than the first distance 111 and may be zero. In the tightened condition, the combination coupling 20, 20′ and pipe element 22 may have sufficient axial rigidity that when an assembled joint is pressurized to its rated pressure (which may be from about 100 psi to about 750 psi, or more particularly from about 250 psi to about 500 psi) the pipe elements do not axially pull out of the joint more than a negligible amount (a negligible amount being not more than approximately the amount which is due to the inherent compliance of the components as opposed to movement of one component relative to another due to a lack of forceful contact or mechanical interlock between the components). Optionally, as shown in FIGS. 9-11 and 20-22, in the initial condition (which may be a preassembled condition), the stop surfaces 42 may be in spaced relation. In the tightened condition, shown in FIGS. 1 and 24, the stop surfaces 42 on respective ends of the segments 28a, 28b may engage each other.

As shown in FIGS. 17-19, as the segments 28a, 28b are drawn together from the initial condition (shown in FIG. 17) to the tightened condition (shown in FIGS. 15, 16, and 19), each arcuate projection 94 of the coupling 20, 20′ wedges in the groove 60. The geometry of the arcuate projection 94 of the coupling 20, 20′ and the geometry of the groove 60 of the pipe element 20 promote the wedging of the arcuate projection 94 in the groove 60.

In an example aspect, with reference to FIG. 19, in the tightened condition and in a cross-sectional plane including the longitudinal axis 52, at least a portion of the arcuate projection 94 has a width W_{AC} (extending parallel or substantially parallel (for example within 5° of parallel) to the longitudinal axis 52) that causes the arcuate projection 94 to forcefully contact the first groove side surface 64 and second groove side surface 68 and wedge in the groove 60. In the example shown in FIGS. 17-19, forceful contact between the arcuate projection 94 and the groove 60 occurs at contact point 61. To cause the wedging, the width W_{AC} of the portion of the arcuate projection 94 in forceful contact with the first and second groove side surfaces 64, 68 (shown in FIG. 19), is wider than a width W_{GC} (extending parallel or substantially parallel (for example within 5° of parallel) to the longitudinal axis 52) of the groove 60 at the same or substantially same location as the point of contact 61 when the coupling 20, 20′ is in the initial condition (shown in FIG. 17).

In an example aspect, in the tightened condition and in a cross-sectional plane including the longitudinal axis 52, a cross-sectional area 63 of the arcuate projection 94 (shown in FIG. 19) is defined by the first mating surface 100, second mating surface 102, and a plane 69 intersecting the first end 65 of the first groove side surface 64 and the second end 72 of the second groove side surface 68. In the initial condition and in a cross-sectional plane including the longitudinal axis 52, a cross-sectional area 73 of the groove 60 (shown in FIG. 17) is defined by the first groove side surface 64, the second groove side surface 68, and a plane 71 intersecting the first end 65 of the first groove side surface 64 and the second end 72 of the second groove side surface 68. Cross-sectional area 63 of the arcuate projection 94 may be greater than the cross-sectional area 73 of the groove such that the arcuate projection 94 wedges in the groove 60.

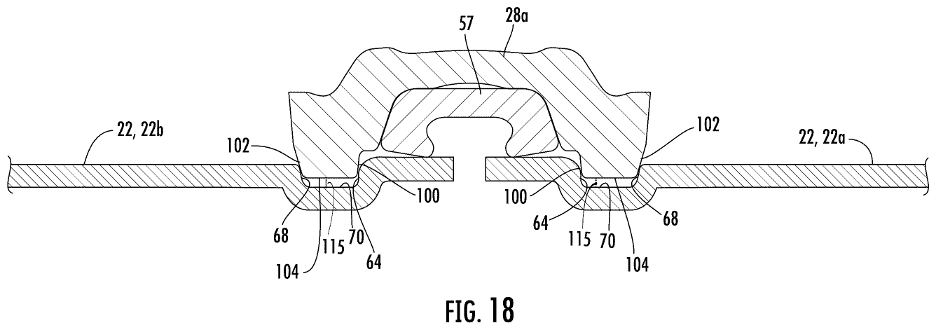

In an example aspect, as shown in FIG. 17, to cause the wedging of the arcuate projection 94 in the groove 60, the width W_{3RD} of the third mating surface 104 may be greater than a width W_{F} of the floor surface 70 of the groove 60 in the pipe element 22. When the width W_{3RD} of the third mating surface 104 is greater than a width W_{F} of the floor surface 70 of the groove 60 in the pipe element 22, the first mating surface 100 and the second mating surface 102 engage the first groove side surface 64 and the second groove side surface 68, respectively, before the segments 28a, 28b reach the tightened condition. In an intermediate condition before the segments reach the tightened condition, the first mating surface 100 and the second mating surface 102 engage the groove side surface 64, 68, and the third mating surface 104 is spaced from the floor surface 70 of the groove 60 by a third distance 115 (shown in FIG. 18). The third distance 115 is greater than the second distance 113.

Projections or keys which have a third mating surface having an axial width smaller than the axial width of the floor of the groove, and generally have a cross-sectional area smaller than the cross-sectional area of the groove, may undesirably allow some slippage of the segments of the coupling relative to the pipe element before the sidewall(s) of the key contacts the sidewall(s) of the groove. Unlike the projections which have a third mating surface having an axial width smaller than the axial width of the floor of the groove (and smaller cross-sectional area), the arcuate projection 94 is configured to axially fill the groove 60, thereby reducing or avoiding unwanted slippage.

Optionally, with reference to FIGS. 17 and 19, the groove 60 flexes open and the third mating surface 104 may approach the floor surface 70 of the groove 60 such that:
in the initial condition, the first groove side angle 88 is a first angle 108 and the second groove side angle 90 is a second angle 110;
in the tightened condition, the first groove side angle 88 is a third angle 112 and the second groove side angle 90 is a fourth angle 114;
the third angle 112 is greater than the first angle 108 and fourth angle 114 is greater than the second angle 110; and
the second distance 113 between the third mating surface 104 and the floor surface 70 of the groove 60 is less than the first distance 111 (and may be zero) between the third mating surface 104 and the floor surface 70 of the groove 60.

In some aspects, the mating surfaces 100, 102, and/or 104 of the arcuate projection(s) 94 and/or the side surfaces 64 and/or 68 of the groove 60 may experience localized deformation, including surface deformation, as the arcuate projection 94 is wedged into the groove 60. It is expected that there will be varied combinations of flexing open of the groove 60 and localized deformation of the groove 60 as the arcuate projection 94 is wedged into the groove 60 across varying tolerances of groove 60 and arcuate projection 94.

The wedging action of the arcuate projection 94 and groove 60 promotes a more rigid joint. The coupling 20, 20′ promotes wedging by producing forceful contact between the arcuate projections 94 of the segments 28a, 28b and the first groove side surface 64 and the second groove side surface 68 of the groove 60 of the pipe element over a broad tolerance range of groove diameters and a broad tolerance range of diameters of the arcuate projection surfaces (corresponding to the diameters of the best fit curves of the arcuate surfaces) of the segments as measured from the center of the respective segment. FIGS. 15 and 16 show the segments 28a, 28b in a tightened condition after the adjustable fasteners 44 have been tightened at different points within the tolerance ranges of the circumferential grooves in the pipe elements and within the tolerance ranges of the arcuate surfaces of the coupling segments (i.e. between a first extreme where the pipe groove diameter is largest and the arcuate surface diameter is smallest and a second extreme where the pipe groove diameter is smallest and the arcuate surface diameter is largest). The configurations described in FIGS. 15 and 16 are illustrative of certain tolerance conditions, and the full range of tolerance conditions encountered in field applications is contemplated within the scope of the disclosed couplings and joints, including tolerance conditions in between those specifically illustrated or recited herein.

As shown in FIG. 15, in a tightened condition under a first tolerance that may be at or near the higher end point of the groove diameter tolerance range and at or near the lower end point of the arcuate projection surfaces diameter range, the first mating surface 100 and the second mating surface 102 of the arcuate projection 94 may wedge open the first groove side surface 64 and the second groove side surface 68 such that the third mating surface 104 of the arcuate projection 94 engages the floor surface 70 of the groove 60.

As shown in FIG. 16, in a tightened condition under a second tolerance that is at or near the lower end point of the groove diameter tolerance range and at or near the higher end point of the arcuate projection surfaces diameter range, the first mating surface 100 and the second mating surface 102 of the arcuate projection 94 may wedge open the first groove side surface 64 and the second groove side surface 68 such that the third mating surface 104 of the arcuate projection 94 is spaced from the floor surface 70 of the groove 60. Tightened conditions under tolerance ranges between the tolerance ranges shown in FIGS. 15 and 16 may result in less space between the third mating surface 104 of the arcuate projection 94 and the floor surface 70 of the groove 60 than the space shown in FIG. 16.

As shown in FIG. 1, as the adjustable fasteners 44 are adjusted to draw the first and second segments 28a, 28b toward one another to the tightened condition, the stop surfaces 42 of the segments 28a, 28b may engage. At a certain point, engagement between the arcuate projections 94 and the circumferential grooves 60 of the pipe element 22 may prevent the segments 28a, 28b from drawing towards one another. At this point, the bending stiffness of the lugs 40 of coupling 20 is tuned such that further tightening of the adjustable fasteners 44 may allow the lugs 40 to bend toward one another respectively until the respective stop surfaces 42 engage (see FIG. 1). The geometry of the stop surfaces 42, their lengths, positions on the segments and orientation angles are coordinated with the arcuate projections 94 such that the projections wedge or lock up effectively within the circumferential grooves 60 of the pipe elements 22 when the stop surfaces 42 respectively engage, or nearly engage, in the tightened condition as depicted in FIG. 1. Thus, engagement between the stop surfaces 42 may serve as final visual confirmation that the coupling 20 has been properly installed and is in the tightened condition. The stop surfaces 42 may provide this visual confirmation over the entire tolerance range (from the lower end point of the tolerance range to the higher end point of the tolerance range) imposed on the circumferential grooves in the pipe elements.

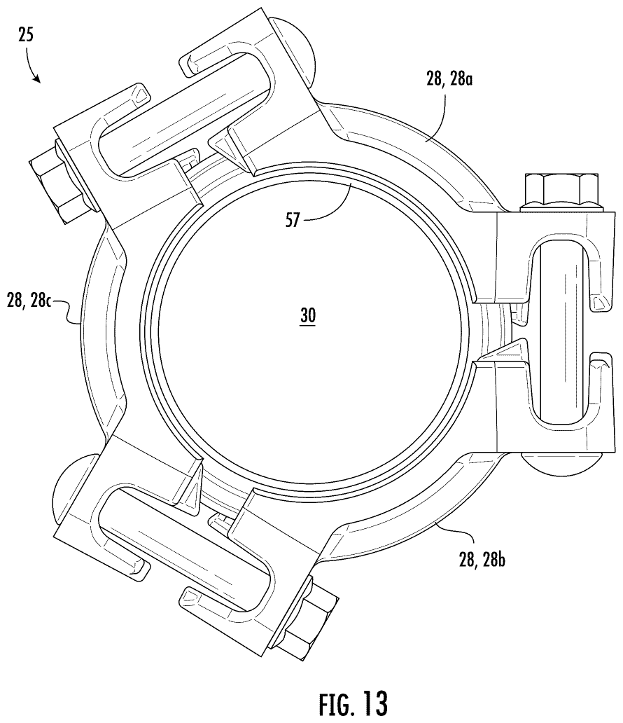

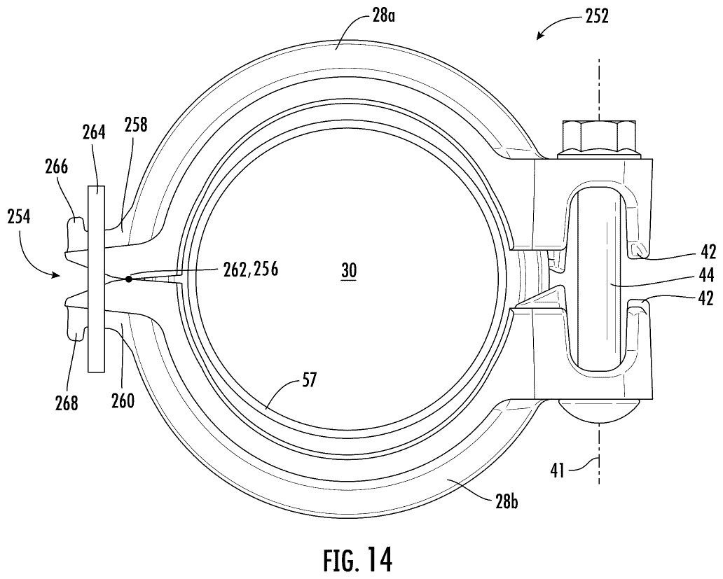

The details of the couplings 20 and 20′ described herein, particularly with respect to the arcuate projections 94 and the wedging effect of the arcuate projections 94 in the groove 60, may be applied to various forms of grooved couplings. In particular, the arcuate projections 94 and the wedging engagement described herein may be incorporated into couplings similar to couplings 20 and 20′ described herein, but which are not provided in a preassembled state and which are instead assembled about a pair of pipe elements 22. As another example, the arcuate projections 94 and the wedging engagement described herein may be incorporated into couplings having different segment configurations, attachment mechanisms, or other structural variations. For instance, FIGS. 13 and 14 provide example variations of grooved couplings to which the arcuate projection and wedging features described herein may be applied. FIG. 13 illustrates another example embodiment of a coupling 25 according to the invention. Coupling 25 shares many of the features of couplings 20 and 20′ as described herein but comprises three segments 28 attached to one another end to end to surround and define the central space 30 for receiving the pipe element. The third segment 28c comprises the same or substantially the same features as the first and second segments 28a, 28b. Although coupling 25 has three segments 28, a coupling having more than three segments is also practical. For example, the coupling may comprise four segments as disclosed herein attached to one another end to end to surround and define the central space 30.

FIG. 14 illustrates another example embodiment of a coupling 252 according to the disclosure. Coupling 252 shares many of the features of couplings 20 and 20′ as described above but substitutes a hinge 254 in place of corresponding lugs 40. An end of each segment 28a and 28b is connected via the hinge 254 joining the first and second segments 28a, 28b to one another. The hinge 254 defines a hinge axis 256 oriented transversely to the longitudinal axis 41 of the first fastener 44. The first and second segments 28a and 28b are pivotable about the hinge axis 256. Adjusting the fastener 44 pivots and thereby draws the first segment 28a and the second segment 28b toward one another. Optionally, the coupling 252 may include stop surfaces 42. Optionally, engagement between the stop surfaces 42 on the lugs 40 arrests rotation of the segments 28a, 28b relative to one another. In this example embodiment, hinge 254 comprises cantilevers 258, 260 engaging one another at a fulcrum 262. Cantilevers 258, 260 are joined by a ring 264, retained by projecting heads 266, 268 on each cantilever. Other forms of hinged joints, such as saddle and stirrup hinges, pinned hinges, cast hinges, and the like, are also contemplated.

Consistent with the above description, a method of assembling a combination of the pipe element 22 and the coupling 20, 20′ comprises, aligning a first pipe element 22a with an arcuate projection 94 of a prior to adjusting the attachment members 36, inserting a first pipe element 22 end first into the central space 30 of the coupling 20, 20′ in a preassembled state such that the a first arcuate projection 94 is aligned with groove 60 of the first pipe element 22. The method further comprises inserting a second pipe element 22b end first into the central space 30 such that a second arcuate projection 94 is aligned with groove 60 of second pipe element 22.

The method comprises adjusting the attachment members 36 to draw the plurality of segments 28 from an initial condition to a tightened condition, wherein the arcuate projection 94 wedges into the groove 60. Adjusting the attachment members 36 causes the first mating surface 100 to engage the first groove side surface 64 and the second mating surface 102 to engage the second groove side surface 68. Optionally, adjusting the attachment members 36 may cause the first groove side surface 64 and the second groove side surface 68 to flex away from each other. Adjusting the attachment members 36 causes the first groove side angle 88 to increase and the second groove side angle 90 to increase. Adjusting the attachment members 36 may cause the stop surfaces 42 on respective ends of the segments 28 to engage each other.

An alternative method of assembling a combination of the pipe element 22 and a coupling 20, 20′ as disclosed herein comprises: aligning groove 60 of a first pipe element 22a with a first arcuate projection 94 of coupling segment 28a; aligning groove 60 of a second pipe element 22b with a second arcuate projection 94 of coupling segment 28a; aligning arcuate projections 94 of a second coupling segment 28b with grooves 60 of pipe elements 22a and 22b, respectively. The method further comprises adjusting the attachment members 36 to draw the segments 28a, 28b from an initial condition to a tightened condition, wherein the arcuate projections 94 wedges into the grooves 60 of pipe elements 22a, 22b as described herein.

### Roller Sets

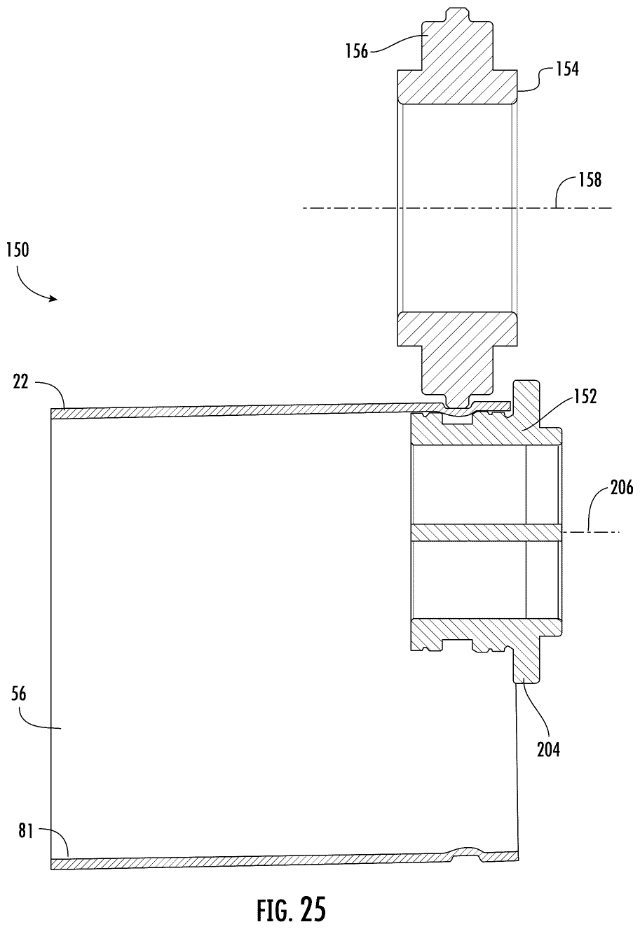

As shown in FIG. 25, a roller set 150 is provided for forming an endform 80 of a pipe element 22. The pipe element 22 has a sidewall 50 surrounding a longitudinal axis 52 and defining a bore 54. The longitudinal axis 52 is a central axis of the pipe element 22. The sidewall 50 has an outer surface 56 and an inner surface 81.

The roller set 150 comprises an inner roller 152 and an outer roller 154. The inner roller 152 comprises an inner roller body 204 rotatable about a second axis 206. The outer roller 154 comprises an outer roller body 156 rotatable about a first axis 158.

A method for forming the endform 80 of the pipe element 22 using the roller set 150 comprises positioning the inner surface of the pipe element 22 on the inner roller 152. The method comprises moving the outer roller 154 into contact with the outer surface 56 of the pipe element 22. The method comprises rotating the inner roller 152, thereby rotating the pipe element 22 and the outer roller 154. The method comprises forcing the inner roller 152 and the outer roller 154 toward one another to deform the pipe element 22 to form the endform 80. The endform 80 comprises a groove 60 defined by the outer surface 56. The groove 60 extends circumferentially around the bore 54. The groove 60 comprises, in a cross-sectional plane including the longitudinal axis 52, a first groove side surface 64, a second groove side surface 68 facing the first groove side surface 64 and in spaced apart relation from the first groove side surface 64 along the longitudinal axis 52, and a floor surface 70 contiguous with (connected, either directly or through a transition region, to) the first groove side surface 64 and the second groove side surface 68. The first groove side surface 64 and the second groove side surface 68 may be configured to flex open upon receiving an arcuate projection of a coupling.

### CONCLUSION

It is expected that the example pipe element and coupling according to the disclosure will improve the rigidity of coupled pipe elements, specifically on thin wall pipe, by promoting wedging of the arcuate projection in the groove around the circumference of the pipe element. The geometry of the groove and the geometry of the arcuate projection, which are configured to promote wedging of the arcuate projection in the groove, may provide more consistent forceful contact between the mating surfaces of the arcuate projection and the side surfaces of the groove. This more consistent engagement may reduce or eliminate the play between the coupling key and the groove that can reduce rigidity in conventional grooved coupling joints. Additionally, because the wedging action does not rely primarily on clamping the groove floor, the disclosed pipe elements and couplings may provide improved rigidity even for thin wall pipe applications where pipe stiffness is reduced.

All of the embodiments of the claimed disclosure described herein are provided expressly by way of example only. Innumerable variations and modifications may be made to the example embodiments described herein without departing from the concept of this disclosure. Additionally, the scope of this disclosure is intended to encompass any and all modifications and combinations of all elements, features, and aspects described in the specification and claims, and shown in the drawings. Any and all such modifications and combinations are intended to be within the scope of this disclosure.

### EXEMPLARY ASPECTS

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.
Aspect 1: A pipe element having a sidewall surrounding a longitudinal axis and defining a bore, said longitudinal axis being a central axis of said pipe element, said sidewall having an outer surface, said sidewall comprising:
an endform; and
a tubular portion connected to said endform, wherein said endform extends from an end of said pipe element to said tubular portion; wherein said endform comprises:
a groove defined by said outer surface, said groove configured to receive an arcuate projection of a coupling, said groove extending circumferentially around said bore, said groove comprising:
a first groove side surface terminating at a first end,
a second groove side surface facing said first groove side surface and in spaced apart relation from said first groove side surface, wherein said first groove side surface is positioned between said end of said pipe element and said second groove side surface, and
a floor surface contiguous with said first groove side surface and said second groove side surface,
wherein said groove is configured to flex open to receive said arcuate projection of said coupling.
Aspect 2: The pipe element according to Aspect 1, wherein said first groove side surface is oriented at a first groove side angle relative to said floor surface and said second groove side surface is oriented at a second groove side angle relative to said floor surface.
Aspect 3: The pipe element according to Aspect 2, wherein said second groove side angle is greater than said first groove side angle.
Aspect 4: The pipe element according to any one of Aspects 2-3, wherein said first groove side angle is a first obtuse angle.
Aspect 5: The pipe element according to any one of Aspects 2-4, wherein said second groove side angle is a second obtuse angle.
Aspect 6: The pipe element according to any one of Aspects 2-5, wherein said first groove side angle and said second groove side angle are each from about 90° to about 120°.
Aspect 7: The pipe element according to any one of Aspects 1-6, wherein said floor surface is oriented parallel or substantially parallel to said longitudinal axis.
Aspect 8: The pipe element according to any one of Aspects 1-7, wherein a radius of said floor surface measured from said longitudinal axis is less than any other radius of said outer surface of said endform measured from said longitudinal axis.
Aspect 9: The pipe element according to any one of Aspects 1-8, wherein a radius of said floor surface measured from said longitudinal axis is less than a minimum radius of said tubular portion measured from said longitudinal axis.
Aspect 10: The pipe element according to any one of Aspects 1-9, wherein said endform further comprises a sealing surface positioned between said first groove side surface and said end.
Aspect 11: The pipe element according to Aspect 10, wherein said sealing surface extends from said first groove side surface to said end.
Aspect 12: The pipe element according to any one of Aspects 10-11, wherein said sealing surface is frustoconical.
Aspect 13: The pipe element according to Aspect 12, wherein a radius of said sealing surface measured from said longitudinal axis at a first point is less than a radius of said sealing surface measured from said longitudinal axis at a second point, wherein said first point is closer to said end of said pipe element than said second point to said end of said pipe element.
Aspect 14: The pipe element according to Aspect 12, wherein a radius of said sealing surface measured from said longitudinal axis at a first point is larger than a radius of said sealing surface measured from said longitudinal axis at a second point, wherein said first point is closer to said end of said pipe element than said second point to said end of said pipe element.
Aspect 15: The pipe element according to any one of Aspects 10-11, wherein said sealing surface is cylindrical or substantially cylindrical.
Aspect 16: The pipe element according to any one of Aspects 1-15, wherein said first end of said first groove side surface is a first summit.
Aspect 17: The pipe element according to Aspect 16, wherein said endform further comprises a sealing surface positioned between said first summit and said end of said pipe element.
Aspect 18: The pipe element according to Aspect 17, wherein said sealing surface extends from said first summit to said end of said pipe element.
Aspect 19: The pipe element according to any one of Aspects 17-18, wherein said sealing surface is frustoconical such that said sealing surface has a smaller radius measured from said longitudinal axis at a point closer to said end of said pipe element than at a point further from said end of said pipe element.
Aspect 20: The pipe element according to any one of Aspects 1-19, wherein said pipe element is a thin wall pipe.
Aspect 21: The pipe element according to any one of Aspects 1-20, wherein said pipe element is a stainless steel pipe.
Aspect 22: The pipe element according to any one of Aspects 2-6, wherein said groove is configured such that:
prior to receiving said arcuate projection, said groove is in an initial condition, wherein in said initial condition, said first groove side angle is a first angle and said second groove side angle is a second angle;
after receiving said arcuate projection, said groove is in a tightened condition, wherein in said tightened condition, said first groove side angle is a third angle and said second groove side angle is a fourth angle; and
said third angle is greater than said first angle and said fourth angle is greater than said second angle.
Aspect 23: In combination, a pipe element and a coupling, said pipe element having a sidewall surrounding a longitudinal axis and defining a bore, said longitudinal axis being a central axis of said pipe element, said sidewall having an outer surface, said sidewall comprising:
an endform; and
a tubular portion connected to said endform, wherein said endform extends from an end of said pipe element to said tubular portion; wherein said endform comprises:
a groove defined by said outer surface, said groove extending circumferentially around said bore, said groove comprising, in a cross-sectional plane including said longitudinal axis:
a first groove side surface,
a second groove side surface facing said first groove side surface and in spaced apart relation from said first groove side surface, wherein said first groove side surface is positioned between said end of said pipe element and said second groove side surface, and
a floor surface contiguous with said first groove side surface and said second groove side surface;
said coupling comprising:
a plurality of segments attached to one another end to end surrounding a central space and said end of said pipe element;
attachment members positioned at each end of said segments for attaching said segments to one another; and
an arcuate projection positioned on a side of each of said segments, wherein said groove of said pipe element is configured to receive said arcuate projection, said arcuate projection comprising:
a first mating surface configured to engage said first groove side surface,
a second mating surface configured to engage said second groove side surface, and
a third mating surface contiguous with said first mating surface and said second mating surface and facing said central space, said third mating surface positioned between said first mating surface and said second mating surface,
wherein, when received by said groove, said arcuate projection is configured to wedge open said groove.
Aspect 24: The combination according to Aspect 23, wherein said first groove side surface is oriented at a first groove side angle relative to said floor surface and said second groove side surface is oriented at a second groove side angle relative to said floor surface.
Aspect 25: The combination according to Aspect 24, wherein said second groove side angle is greater than said first groove side angle.
Aspect 26: The combination according to any one of Aspects 24-25, wherein said first groove side angle is an obtuse angle and said second groove side angle is an obtuse angle.
Aspect 27: The combination according to any one of Aspects 23-26, wherein said floor surface has a width extending parallel or substantially parallel to said longitudinal axis, wherein said third mating surface has a width extending perpendicularly or substantially perpendicularly to the length of said arcuate projection, wherein said width of said third mating surface is greater than said width of said floor surface of said groove.
Aspect 28: The combination according to any one of Aspects 23-27, wherein said third mating surface has a width extending perpendicularly or substantially perpendicularly to the length of said arcuate projection, wherein said first mating surface tapers towards said second mating surface and said second mating surface tapers towards said first mating surface such that a base of said arcuate projection is wider than said width of said third mating surface.
Aspect 29: The combination according to any one of Aspects 23-28, wherein said plurality of segments are configured to be drawn towards one another from an initial condition to a tightened condition.
Aspect 30: The combination according to Aspect 29, wherein in said initial condition, said third mating surface is spaced from said floor surface of said groove by a first distance, and in said tightened condition, said third mating surface engages said floor surface of said groove or said third mating surface is spaced from said floor surface of said groove by a second distance, wherein said second distance is less than said first distance.
Aspect 31: The combination according to any one of Aspects 29-30, wherein said first mating surface and said second mating surface engage said first groove side surface and said second groove side surface, respectively, before said segments reach said tightened condition.
Aspect 32: The combination according to any one of Aspects 29-31, wherein as said segments are drawn towards each other to said tightened condition, said arcuate projection wedges into said groove.
Aspect 33: The combination according to any one of Aspects 31-32, wherein, when said first mating surface and said second mating surface engage said first groove side surface and said second groove side surface, respectively, before said segments reach said tightened condition, said third mating surface is spaced from said floor surface of said groove be a third distance, wherein said second distance is less than said third distance
Aspect 34: The combination according to any one of Aspects 30-33, wherein in said tightened condition and in a cross-sectional plane including said longitudinal axis, at least a portion of said arcuate projection has a width extending parallel or substantially parallel to the longitudinal axis configured to cause the arcuate projection to forcefully contact said first groove side surface and said second groove side surface at a contact point, wherein, in said initial condition and in said cross-sectional plane including said longitudinal axis, said groove has a width extending parallel or substantially parallel to the longitudinal axis at the same or substantially same location as the point of contact that is less than said width of said arcuate projection.
Aspect 35: The combination according to any one of Aspects 30-34, wherein said first groove side surface terminates at a first end and said second groove side surface terminates at a second end, wherein said first end of said first groove side surface and said second end of said second groove side surface are not contiguous with said floor surface, wherein in said tightened condition and in a cross-sectional plane including said longitudinal axis, a cross-sectional area of said arcuate projection is defined by said first mating surface, said second mating surface, and a first plane intersecting the first end of the first groove side surface and the second end of said second groove side surface, wherein, in said initial condition and in said cross-sectional plane including said longitudinal axis, a cross-sectional area of said groove is defined by said first groove side surface, said second groove side surface, and a second plane intersecting said first end of said first groove side surface and said second end of said second groove side surface, wherein said cross-section area of said arcuate projection is greater than said cross-section area of said groove.
Aspect 36: The combination according to any one of Aspects 23-35, wherein said plurality of segments are attached to one another end to end in a preassembled state, wherein in said preassembled state, said plurality of segments are supported in spaced relation while attached to one another to allow insertion of said pipe element into said central space.
Aspect 37: The combination according to Aspect 36, wherein said coupling comprises a ring seal configured to support said plurality of segments in said preassembled state.
Aspect 38: The combination according to any one of Aspects 23-37, wherein said plurality of segments comprises a first segment and a second segment, wherein said first segment and said second segment are attached to one another at one end by a hinge and at an opposite end by an adjustable fastener.
Aspect 39: The combination according to any one of Aspects 23-38, wherein said plurality of segments comprises more than two segments attached to surround said central space.
Aspect 40: The combination according to any one of Aspects 23-39, wherein said plurality of segments comprises a first segment and a second segment, wherein said first segment and said second segment are attached to one another at both ends by adjustable fasteners.
Aspect 41: The combination according to any one of Aspects 23-40, wherein each of said segments comprises lugs projecting from opposite ends of each segment, each lug comprising a stop surface, wherein in a tightened condition, said stop surfaces on respective ends of said segments engage each other.
Aspect 42: The combination according to any one of Aspects 29-41, wherein in said tightened condition, said combination has sufficient axial rigidity that when an assembled joint is pressurized to its rated pressure, said pipe element does not axially pull out of the joint more than a negligible amount.
Aspect 43: The combination according to any one of Aspects 23-42, wherein said pipe element is a thin wall pipe.
Aspect 44: The combination according to any one of Aspects 23-43, wherein said pipe element is a stainless steel pipe.
Aspect 45: The combination according to any one of Aspects 23-44, wherein said coupling comprises a ring seal configured to be captured and compressed between said segments and said pipe element when said attachment members are tightened.
Aspect 46: The combination according to any one of Aspects 23-45, wherein said wedging action of said arcuate projection and said groove around the circumference of said pipe element promotes a more rigid joint.
Aspect 47: A method of assembling a combination of a pipe element and a coupling, said pipe element having a sidewall surrounding a longitudinal axis and defining a bore, said longitudinal axis being a central axis of said pipe element, said sidewall having an outer surface comprising an endform, said endform comprising a groove defined by said outer surface, said groove extending circumferentially around said bore; said coupling comprising a plurality of segments attached to one another end to end forming a loop around a central space, attachment members for attaching said segments to one another, and an arcuate projection positioned on a side of each of said segments; said method comprising:
adjusting said attachment members to draw said plurality of segments from an initial condition to a tightened condition, wherein said arcuate projection wedges into said groove.
Aspect 48: The method according to Aspect 47, wherein said groove comprises, in a cross-sectional plane including said longitudinal axis, a first groove side surface, a second groove side surface facing said first groove side surface and in spaced apart relation from said first groove side surface, and a floor surface contiguous with said first groove side surface and said second groove side surface.
Aspect 49: The method according to Aspect 48, wherein said arcuate projection comprises a first mating surface, a second mating surface, and a third mating surface contiguous with said first mating surface and said second mating surface.
Aspect 50: The method according to Aspect 49, wherein adjusting said attachment members causes said first mating surface to engage said first groove side surface and said second mating surface to engage said second groove side surface.
Aspect 51: The method according to any one of Aspects 48-50, wherein adjusting said attachment members causes said first groove side surface and said second groove side surface to flex away from each other.
Aspect 52: The method according to any one of Aspects 48-51, wherein said first groove side surface is oriented at a first groove side angle relative to said floor surface and said second groove side surface is oriented at a second groove side angle relative to said floor surface.
Aspect 53: The method according to Aspect 52, wherein adjusting said attachment members causes said first groove side angle to increase and said second groove side angle to increase.
Aspect 54: The method according to any one of Aspects 52-53, wherein said first groove side angle is an obtuse angle and said second groove side angle is an obtuse angle.
Aspect 55: The method according to any one of Aspects 52-54, wherein said second groove side angle is greater than said first groove side angle.
Aspect 56: The method according to any one of Aspects 49-55, wherein in said initial condition, said third mating surface is spaced from said floor surface by a first distance, and in said tightened condition, said third mating surface is spaced from said floor surface by a second distance less than said first distance or said third mating surface engages said floor surface.
Aspect 57: The method according to any one of Aspects 49-56, wherein said floor surface has a width extending parallel or substantially parallel to said longitudinal axis, and wherein said third mating surface has a width extending perpendicularly or substantially perpendicularly to a length of said arcuate projection, wherein said width of said third mating surface is greater than said width of said floor surface.
Aspect 58: The method according to any one of Aspects 47-57, wherein said plurality of segments comprise lugs having stop surfaces, and wherein adjusting said attachment members causes said stop surfaces on respective ends of said segments to engage each other.
Aspect 59: The method according to any one of Aspects 47-58, wherein said pipe element is a thin wall pipe.
Aspect 60: The method according to any one of Aspects 47-59, wherein said pipe element is a stainless steel pipe.
Aspect 61: A method of forming a pipe element having a sidewall surrounding a longitudinal axis and defining a bore, said longitudinal axis being a central axis of said pipe element, said sidewall having an outer surface and an inner surface, said method comprising:
positioning said inner surface of said pipe element on an inner roller of a roller set, said inner roller comprising an inner roller body rotatable about a second axis;
moving an outer roller of said roller set into contact with said outer surface of said pipe element, said outer roller comprising an outer roller body rotatable about a first axis;
rotating said inner roller, thereby rotating said pipe element and said outer roller; and
forcing said inner and outer rollers toward one another to deform said pipe element to form an endform comprising a groove defined by said outer surface, said groove extending circumferentially around said bore, said groove comprising, in a cross-sectional plane including said longitudinal axis, a first groove side surface, a second groove side surface facing said first groove side surface and in spaced apart relation from said first groove side surface, and a floor surface contiguous with said first groove side surface and said second groove side surface, wherein said first groove side surface and said second groove side surface are configured to flex open upon receiving an arcuate projection of a coupling.

What is claimed is:

1. In combination, a pipe element and a coupling, said pipe element having a sidewall surrounding a longitudinal axis and defining a bore, said longitudinal axis being a central axis of said pipe element, said sidewall having an outer surface, said sidewall comprising:
an endform; and
a tubular portion connected to said endform, wherein said endform extends from an end of said pipe element to said tubular portion; wherein said endform comprises:
a groove defined by said outer surface, said groove extending circumferentially around said bore, said groove comprising:
a first groove side surface,
a second groove side surface facing said first groove side surface and in spaced apart relation from said first groove side surface, wherein said first groove side surface is positioned between said end of said pipe element and said second groove side surface, and
a floor surface contiguous with said first groove side surface and said second groove side surface;
said coupling comprising:
a plurality of segments attached to one another end to end surrounding a central space and said end of said pipe element;
attachment members positioned at each end of said segments for attaching said segments to one another; and
an arcuate projection positioned on a side of each of said segments, wherein said groove of said pipe element is configured to receive said arcuate projection, said arcuate projection comprising:
a first mating surface configured to engage said first groove side surface,
a second mating surface configured to engage said second groove side surface, and
a third mating surface contiguous with said first mating surface and said second mating surface and facing said central space, said third mating surface positioned between said first mating surface and said second mating surface,
wherein when received by said groove, said arcuate projection is configured to wedge into said groove.

2. The combination according to claim 1, wherein said first groove side surface is oriented at a first groove side angle relative to said floor surface and said second groove side surface is oriented at a second groove side angle relative to said floor surface.

3. The combination according to claim 2, wherein said second groove side angle is greater than said first groove side angle.

4. The combination according to claim 2, wherein said first groove side angle is an obtuse angle and said second groove side angle is an obtuse angle.

5. The combination according to claim 1, wherein said floor surface has a width extending parallel or substantially parallel to said longitudinal axis, wherein said third mating surface has a width extending perpendicularly or substantially perpendicularly to the length of said arcuate projection, wherein said width of said third mating surface is greater than said width of said floor surface of said groove.

6. The combination according to claim 1, wherein said third mating surface has a width extending perpendicularly or substantially perpendicularly to the length of said arcuate projection, wherein said first mating surface tapers towards said second mating surface and said second mating surface tapers towards said first mating surface such that a base of said arcuate projection is wider than said width of said third mating surface.

7. The combination according to claim 1, wherein said plurality of segments are configured to be drawn towards one another from an initial condition to a tightened condition.

8. The combination according to claim 7, wherein in said initial condition, said third mating surface is spaced from said floor surface of said groove by a first distance, and in said tightened condition, said third mating surface engages said floor surface of said groove or said third mating surface is spaced from said floor surface of said groove by a second distance, wherein said second distance is less than said first distance.

9. The combination according to claim 8, wherein said first mating surface and said second mating surface engage said first groove side surface and said second groove side surface, respectively, before said segments reach said tightened condition.

10. The combination according to claim 7, wherein as said segments are drawn towards each other to said tightened condition, said arcuate projection wedges into said groove.

11. The combination according to claim 9, wherein, in an intermediate condition before said segments reach said tightened condition, said first mating surface and said second mating surface engage said first groove side surface and said second groove side surface, respectively, and said third mating surface is spaced from said floor surface of said groove by a third distance, wherein said second distance is less than said third distance.

12. The combination according to claim 8, wherein in said tightened condition and in a cross-sectional plane including said longitudinal axis, at least a portion of said arcuate projection has a width extending parallel or substantially parallel to the longitudinal axis configured to cause the arcuate projection to forcefully contact said first groove side surface and said second groove side surface at a contact point, wherein, in said initial condition and in said cross-sectional plane including said longitudinal axis, said groove has a width extending parallel or substantially parallel to the longitudinal axis at the same or substantially same location as the point of contact that is less than said width of said arcuate projection.

13. The combination according to claim 8, wherein said first groove side surface terminates at a first end and said second groove side surface terminates at a second end, wherein said first end of said first groove side surface and said second end of said second groove side surface are not contiguous with said floor surface, wherein in said tightened condition and in a cross-sectional plane including said longitudinal axis, a cross-sectional area of said arcuate projection is defined by said first mating surface, said second mating surface, and a first plane intersecting the first end of the first groove side surface and the second end of said second groove side surface, wherein, in said initial condition and in said cross-sectional plane including said longitudinal axis, a cross-sectional area of said groove is defined by said first groove side surface, said second groove side surface, and a second plane intersecting said first end of said first groove side surface and said second end of said second groove side surface, wherein said cross-section area of said arcuate projection is greater than said cross-section area of said groove.

14. The combination according to claim 1, wherein said plurality of segments are attached to one another end to end in a preassembled state, wherein in said preassembled state, said plurality of segments are supported in spaced relation while attached to one another to allow insertion of said pipe element into said central space.

15. The combination according to claim 14, wherein said coupling comprises a ring seal configured to support said plurality of segments in said preassembled state.

16. The combination according to claim 1, wherein said plurality of segments comprises a first segment and a second segment, wherein said first segment and said second segment are attached to one another at one end by a hinge and at an opposite end by an adjustable fastener.

17. The combination according to claim 1, wherein said plurality of segments comprises more than two segments attached to one another end to end to surround said central space.

18. The combination according to claim 1, wherein said plurality of segments comprises a first segment and a second segment, wherein said first segment and said second segment are attached to one another at both ends by adjustable fasteners.

19. The combination according to claim 1, wherein each of said segments comprises lugs projecting from opposite ends of each segment, each lug comprising a stop surface, wherein in a tightened condition, said stop surfaces on respective ends of said segments engage each other.

20. The combination according to claim 1, wherein said pipe element is a stainless steel pipe.

21. A method of assembling a combination of a pipe element and a coupling, said pipe element having a sidewall surrounding a longitudinal axis and defining a bore, said longitudinal axis being a central axis of said pipe element, said sidewall having an outer surface comprising an endform, said endform comprising a groove defined by said outer surface, said groove extending circumferentially around said bore; said coupling comprising a plurality of segments attached to one another end to end to surround a central space, attachment members for attaching said segments to one another, and an arcuate projection positioned on a side of each of said segments; said method comprising:
adjusting said attachment members to draw said plurality of segments from an initial condition to a tightened condition, wherein said arcuate projection wedges into said groove.

22. The method according to claim 21, wherein said groove comprises, in a cross-sectional plane including said longitudinal axis, a first groove side surface, a second groove side surface facing said first groove side surface and in spaced apart relation from said first groove side surface, and a floor surface contiguous with said first groove side surface and said second groove side surface.

23. The method according to claim 22, wherein said arcuate projection comprises a first mating surface, a second mating surface, and a third mating surface contiguous with said first mating surface and said second mating surface.

24. The method according to claim 23, wherein adjusting said attachment members causes said first mating surface to engage said first groove side surface and said second mating surface to engage said second groove side surface.

25. The method according to claim 23, wherein said first groove side surface is oriented at a first groove side angle relative to said floor surface and said second groove side surface is oriented at a second groove side angle relative to said floor surface.

26. The method according to claim 25, wherein adjusting said attachment members causes said first groove side angle to increase and said second groove side angle to increase.

27. The method according to claim 25, wherein said first groove side angle is an obtuse angle and said second groove side angle is an obtuse angle.

28. The method according to claim 25, wherein said second groove side angle is greater than said first groove side angle.

29. The method according to claim 23, wherein in said initial condition, said third mating surface is spaced from said floor surface by a first distance, and in said tightened condition, said third mating surface is spaced from said floor surface by a second distance less than said first distance or said third mating surface engages said floor surface.

30. The method according to claim 23, wherein said floor surface has a width extending parallel or substantially parallel to said longitudinal axis, and wherein said third mating surface has a width extending perpendicularly or substantially perpendicularly to a length of said arcuate projection, wherein said width of said third mating surface is greater than said width of said floor surface.

31. The method according to claim 21, wherein said plurality of segments comprise lugs having stop surfaces, and wherein adjusting said attachment members causes said stop surfaces on respective ends of said segments to engage each other.
